(19) United States
(12) Patent Application Publication
(10) Pub. No.: US 2003/0198307 A1
(43) Pub. Date: Oct. 23, 2003

(54) Dynamic clock control to reduce radio interference in digital equipment

(75) Inventors: Timothy Neill, Houston, TX (US); Chrismal R. Panditharathne, Houston, TX (US)

Correspondence Address: CONLEY ROSE, P.C., P. O. BOX 3267, HOUSTON, TX, 77253-3267, US

(73) Assignee: Compaq Information, Houston, TX

(21) Appl. No.: 10/126,901

(22) Filed: Apr. 19, 2002

(51) Int. Cl. H04L 1/00

(52) U.S. Cl. 375/346

(57) ABSTRACT

A system and method of using dynamic clock control to reduce RF interference in digital equipment is disclosed. In one embodiment, the digital equipment comprises a clock module, a wireless module, and a control module. The wireless module is designed to receive RF signals, but may also receive RF interference from the digital equipment. The control module responsively adjusts the clock module to reduce the RF interference, preferably by shifting clock signal harmonics outside selected frequency regions of interest (e.g., a receive channel). The selected frequency regions may change, e.g., due to channel hopping. The control module preferably continues to shift the clock signal harmonics as needed to reduce RF interference. The control module may also adjust display scan rates, hardware states, and computational load assignments. The control module may be further configured to adaptively minimize the RF interference.

### BACKGROUND

1. Field of the Invention

This invention generally relates to methods for reducing radio interference. More specifically, this invention relates to systems and methods that dynamically reduce radio interference in spectral regions of interest.

2. Description of Related Art

There has long been an interest in equipping computers with wireless communications capability, but only recently has such capability been viewed as a necessity. The proliferation of powerful, portable electronic devices has created a commensurate need for facilitating communication between these devices. Existing interface cables and hard-wired communications protocols have proven to be cumbersome and limiting. Accordingly, system designers now provide a wireless communications capability for most modem portable electronic devices.

Five major types of (portable) wireless communications capability exist today: infrared ports, wireless personal area networks (WPANs), wireless local area networks (WLANs), cellular or wireless wide area networks (WWANs), and satellite. Devices equipped with infrared ports communicate through the use of infrared signals, while devices using the other four major types of wireless communications communicate through the use of radio frequency (RF) signals. Infrared signals are easily blocked, and the typical communications range is very limited (e.g., about 5 meters). WPANs generally use very low power RF signals, which typically limits the communications range to approximately 10 meters or so. (Their target application is cable replacement.) WLANs are wireless alternatives to wire-based local area networks (LANs), and their range is approximately 100 meters. The communications range of cellular devices is substantially greater (about 20 kilometers), and they rely on a network of cellular base stations to communicate anywhere the telecommunications network will reach. Similarly, satellite phones can access a base station several thousand kilometers away via a network of earth-orbiting satellites, and communicate anywhere the telecommunications network will reach.

In all wireless communications, the energy transmitted to a receiving device falls off rapidly as the distance from the transmitting device increases. To provide adequate communications range, the receiving devices are generally required to maintain high sensitivities (e.g., on the order of −175 dBm/Hz). Nearby sources of RF interference can easily degrade the performance of high-sensitivity receivers. Such RF interference is a common, undesirable side effect produced by many electronic devices.

The Federal Communications Commission (FCC) regulates (among other things) the use of RF signals. As part of those regulations, the FCC limits the amount of RF energy that electronic devices can emit. Device manufacturers typically employ four standard techniques (alone or in combination) to achieve compliance with FCC regulations.

The first technique, hardware redesign, involves creating a circuit layout having minimal RF emissions. This often includes minimizing conductor lengths, avoiding sharp bends, minimizing electric field strengths, and generous use of ground planes. This design process can be unpredictable and expensive, and may in the end still fail to achieve compliance with FCC regulations.

The second technique, electromagnetic shielding, involves enclosing some or all of the circuit with conductive material. The conductive material, often called a “can”, reflects the RF emissions, thereby preventing emitted RF energy from escaping beyond the enclosed region. Adding a can may increase the production cost significantly by increasing the cost of materials.

The third technique, electromagnetic absorption, involves locating materials or devices near the RF emitting portions of the circuit to absorb the emitted RF energy. Such materials and devices can be designed to absorb at the particular frequencies at issue. This technique is often employed at a late stage after the product has already been designed. The costs associated with this technique are two-fold: the cost of the material, and the cost of creating additional space for the material in the device enclosure.

A fourth technique, clock spreading, is applicable to digital devices. Digital devices nearly always operate synchronously, i.e., their operations are performed according to a clock signal. The clock signal and many of the signals it times are digital (i.e., square) signals that switch at the clock frequency. Consequently, digital circuits commonly radiate RF signals in narrow frequency bands at the fundamental frequency of the clock signal and many of its harmonic frequencies. When these narrow band RF signals exceed FCC limits, system designers can generally provide modulation of the clock signal frequency to disperse some of the RF signal energy throughout a wider frequency band, thereby reducing the RF signal energy at any given frequency.

Note, however, that even when FCC regulations are satisfied, the more sensitive receivers may still suffer degraded performance caused by RF interference. This problem is particularly acute when the receiver is in close proximity to the RF interference source, e.g., when the receiver is being embedded in or attached to a digital device. In such circumstances, the first three techniques mentioned above may be employed to further reduce RF interference, at significantly increased cost. For digital devices, the clock spreading technique may not adequately reduce interference levels.

Alternatively, the receiver may be coupled to an external antenna located at a sufficient distance from the interference source. This option adds cable losses between the antenna and the wireless receiver, which adversely affects the receiver sensitivity. It also increases costs due to the need for additional cabling and RF connectors. Further, the external antenna commonly proves to be impractical for many portable devices. Accordingly, a new method for reducing RF interference is needed.

### SUMMARY OF THE INVENTION

The problems outlined above are in large measure addressed by a system and method of using dynamic clock control to reduce RF interference in digital equipment. In one embodiment, the digital equipment comprises a clock module, a wireless module, and a control module. The wireless module is designed to receive RF signals, but may also receive RF interference from the digital equipment. The control module responsively adjusts the clock module to reduce the RF interference, preferably by shifting clock signal harmonics outside selected frequency regions of interest (e.g., a receive channel). The selected frequency regions may change, e.g., due to channel hopping. The control module preferably continues to shift the clock signal harmonics as needed to reduce RF interference. The control module may be further configured to adaptively minimize the RF interference.

In another embodiment, the digital equipment includes a wireless communications device and a processor. The wireless communications device may be subjected to RF interference from the digital equipment, and the processor preferably executes a spectrum control procedure that dynamically reconfigures the equipment to reduce the RF interference in selected frequency regions. The reconfiguration may include altering a clock signal frequency, altering a display scan rate, suspending operation of one or more peripherals, and shifting computational loads. In a contemplated method embodiment, the method comprises: (i) providing a clock signal at an initial clock rate; (ii) identifying a frequency region in which to reduce RF interference; and (iii) adjusting the clock signal to a different, nonzero clock rate that reduces RF interference in the identified frequency region.

### BRIEF DESCRIPTION OF THE DRAWINGS

A better understanding of the present invention can be obtained when the following detailed description is considered in conjunction with the following drawings, in which:

FIG. 1 is a block diagram of a digital device with wireless communications capability;

FIG. 2 is a flowchart of a first dynamic RF interference reduction method;

FIG. 3 is a flowchart of a second dynamic RF interference reduction method;

FIG. 4 is a functional block diagram of a preferred software embodiment;

FIG. 5 is a perspective view of a preferred system embodiment; and

FIG. 6 is a block diagram of one exemplary system embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF PREFERRED EMBODIMENTS

In the following, the term “radio-frequency (RF) signals” is intended to include signals having frequency components anywhere in the range below about 10¹³ Hz.

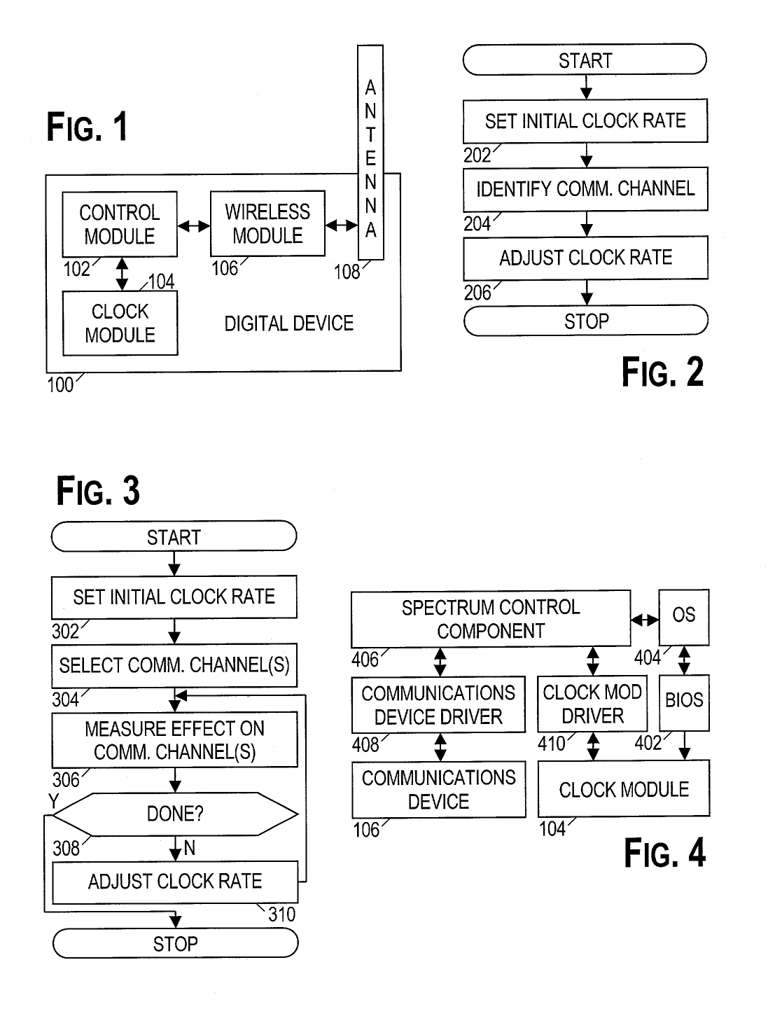

Turning now to the figures, FIG. 1 shows a digital device 100 having wireless communications ability. The device includes a control module 102 coupled to a clock module 104. The clock module 104 generates a clock signal with a programmable clock frequency f. The clock frequency is preferably controllable by the control module 102.

The digital device 100 further includes a wireless module 106 coupled to the control module 102, and further coupled to an antenna 108. Wireless module 106 receives RF signals via antenna 108, and may also transmit RF signals via antenna 108. The wireless module extracts receive data from the RF signals and provides the receive data to the control module. Wireless module 106 may further accept transmit data from control module 102 to be converted into RF signals for transmission. The wireless module may comply with any given wireless communications protocol now known or created in the future, including, e.g., GSM, TDMA, CDMA, and 802.11.

In the preferred embodiment, the wireless module 106 and the control module 102 advantageously cooperate to identify one or more regions of interest in the frequency spectrum, and cooperate to adjust the clock frequency so as to reduce or eliminate the RF interference in those regions. As an example, consider the GSM wireless protocol. In this protocol, the portable device (i.e., device 100) and a cellular base station cooperate to determine transmit and receive channels that are each about 200 kHz in width. The portable device would have greater range and performance if the clock signal produces no harmonics in the dynamically-assigned 200 kHz receive band. Accordingly, after the receive channel has been identified, the control module 102 adjusts the clock frequency (if necessary) to shift any clock harmonics out of the receive band. In the worst case, this would require shifting the fundamental frequency by about 100 kHz. (Shifting higher harmonics by a given amount requires a proportionately smaller shift of the fundamental frequency.) Assuming (conservatively) a clock frequency of 50 MHz, this would be a frequency shift of about 0.2%, which should be well within the tolerance of most digital devices.

FIG. 2 shows a flowchart of one method embodiment. In block 202, an initial clock rate is set. This may be a default clock rate that the clock module begins running at when the system is powered on, or it may be a clock rate that the control module programs the clock module to run at. Many portable devices are designed to adjust clock rates in response to demand so as to offer users an optimal trade-off between high performance and long battery life. In block 204, a wireless communications link has been initiated, and the wireless module communicates the spectral regions of interest (e.g., receive channel(s)) to the control module. In block 206, the control module determines a desired clock rate that reduces or eliminates RF interference in the regions of interest, and reprograms the clock module 104 if necessary.

When determining a desired clock rate, the control module may take into account various factors in addition to the spectral regions of interest. Examples of such factors may include: user preferences, the current clock rate, measurements of noise in the regions of interest, current computational load, power consumption, spectral regions of potential future interest (e.g., channel hopping), previously measured harmonic interference amplitudes, and the availability of other RF interference reducing measures (e.g., shutting down peripheral devices, switching to battery power, altering display scan rates). The control module may also track the history of designated regions of interest, clock rate settings, and/or noise measurements, and consider that history when determining a desired clock rate. Alternatively, a simple rule may be employed, such as “always reduce the clock frequency by the minimum amount required to shift the harmonic out of the region(s) of interest”.

FIG. 3 shows a flowchart of another method embodiment. In this embodiment, the control module scans the clock module through a set of clock rates, and determines the RF interference effect on the spectral region of interest. This may be done as a method of determining an acceptable (or an optimal) clock rate for a given channel in real time, or this may be done ahead of time (e.g., at power on) to construct a table of clock rates and channels. The table could then be used to quickly determine the appropriate clock rate for a given channel.

In block 302, the clock module starts producing a clock signal with an initial clock frequency. In block 304, the wireless module begins monitoring a receive channel. In block 306, the wireless module makes a measurement of the channel noise, and preferably provides some indication of channel quality to the control module. In block 308, the control module tests to determine whether further clock adjustments are desired. The exact test will depend on the circumstances. If this method is being performed to construct a table, further clock adjustments are needed until each possible clock setting (or at least a representative selection of clock settings) has been tested. If this method is being performed to find an acceptable clock setting further adjustments are needed only if the current setting does not provide adequate relief from RF interference. In any event, if no further adjustments are needed, the method completes. Otherwise, the control module adjusts the clock rate in block 310, e.g., incrementing it by a selected amount, and the method returns to block 306, where the wireless module determines the effect of the new clock rate on the channel. In some embodiments, the entire method may be repeated for each of multiple channels. In other embodiments, the method is repeated periodically, and the clock rate adjusted only if the digital device is producing undue RF interference in the selected channel.

FIG. 4 shows a preferred method embodiment in terms of software components. When the digital device powers up, clock module 104 begins producing a clock signal at some initial clock frequency. As part of the power-on process, built-in firmware 402 (e.g., a BIOS routine) may configure the clock module to produce a default clock frequency for operation of the digital device. An operating system 404 running on the device may from time-to-time reconfigure the clock module 104 (typically via firmware 402) to adjust the clock frequency for different operating conditions.

A software component 406 preferably runs on the digital device for controlling the spectrum of the RF energy emitted by various components of the digital device. The spectrum control component 406 may be an application program, e.g., a utility, which is run when an optimal spectrum is desired for a given situation. More preferably, however, component 406 may be a part of the operating system 404 that is activated when the use of a wireless communications link is desired.

As part of its spectrum control function, component 406 receives information from wireless communications device 106 (typically via a device driver 408 implemented in software). Spectrum control component 406 may initiate the retrieval of information from wireless communications device 106, or alternatively, it may take a passive role. The information preferably includes some indication of one or more frequency regions to be targeted for RF interference reduction. The regions may include, for example, one or more channels selected for reception of wireless communications. The spectrum control component 406 responsively determines a desirable clock rate that reduces or minimizes the RF interference in the indicated regions.

The information received from the wireless communications device 106 may further include some indication of channel quality, e.g., signal-to-noise ratio, noise level, bit rate, error rate, or an acceptability flag. If the channel quality information is available, the spectrum control component 406 preferably uses that information (either directly or alternatively in a feedback manner) to determine the desirable clock rate.

The spectrum control component 406 then adjusts the clock module 104 (if necessary) to provide the desired clock rate. The adjustment may be made via the firmware 402, but preferably is made through a separate clock module driver 410. Potential benefits of using a separate clock module driver may include the determination of clock module features such as the range of programmable frequencies, the availability of clock spreading, clock pulse shaping, and any other features that the spectrum control component could use to dynamically reduce RF interference in designated regions of the spectrum.

Thus far, the focus has been on altering the clock frequency to dynamically reduce RF interference in designated regions. However, in the preferred embodiment, the spectrum control component 406 is able to perform additional actions to accomplish the desired RF interference reduction. Examples of potential additional (or alternative actions) to reduce RF interference include: temporary shutdown of peripherals, alteration of display scan rates, alteration of DRAM refresh times, shifting processing loads, clock spreading, and activation of RF suppression circuitry. Peripherals that may be particular candidates for temporary shutdown would be hard disk drives, optical disk drives, and graphics accelerators. The shifting of processing loads may occur in time (e.g., postponing computationally intense tasks) or in space (e.g., moving computationally intense tasks in parallel processing devices to the devices most distant from the antenna). RF suppression may be accomplished in a variety of ways, including grounding of idle signal lines and forming a lossy resonant circuit from idle circuit components. In some instances active cancellation may also be employed.

Although the components of FIG. 4 have been discussed in terms of software, this discussion is not limiting. The functions of these components may also be implemented in hardware or firmware.

FIG. 5 shows a preferred embodiment of digital device 100. Here the digital device takes the form of a portable computer, but other forms are also contemplated, e.g., mobile phones, computer watches, personal digital assistants (PDAs), digital televisions, computers built into vehicles, and so on. FIG. 5 also shows digital information media 504 which may be used to convey software components to digital device 100. The digital information media as shown in FIG. 5 is a portable information storage media such as a floppy disk or an optical disk. Nevertheless, the term digital information media is intended to include any media which can convey software to a digital device. Such media includes computer networks, phone lines, wireless channels, memory chips, magnetic tape, and so on.

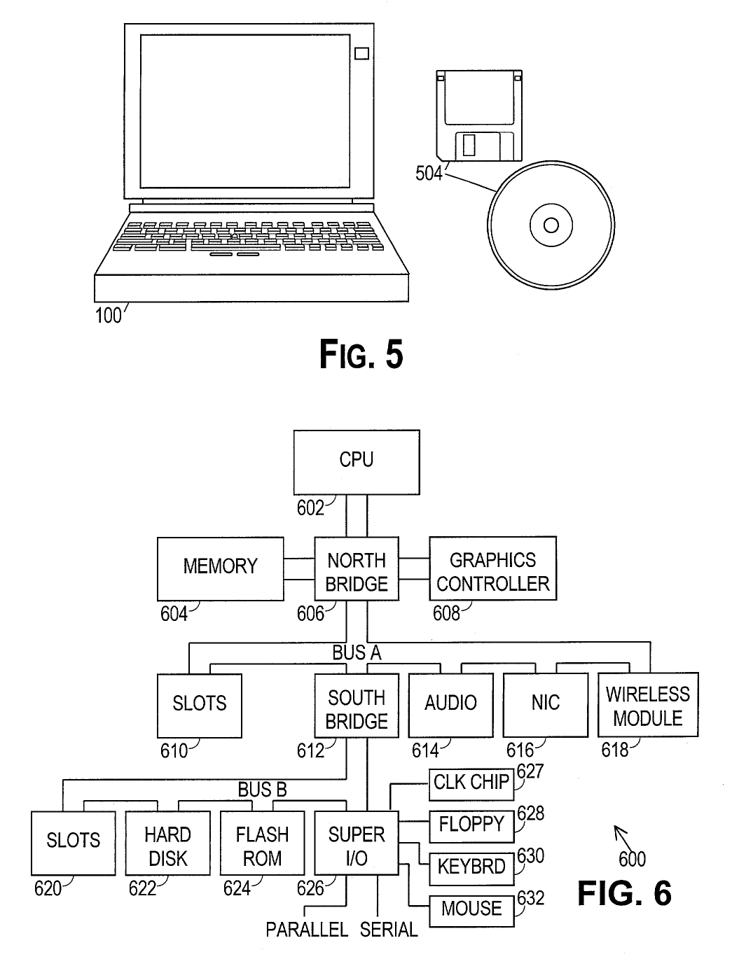

FIG. 6 shows a representative block diagram of a portable computer such as that shown in FIG. 5. Computer 600 includes a processor (CPU) 602 coupled to a bridge logic device 606 via a CPU bus. Bridge logic device 606 is sometimes referred to as a “North bridge” for no other reason than it is often depicted at the upper end of a computer system drawing. The North bridge 606 also couples to a main memory array 604 via a memory bus, and may further couple to a graphics controller 608 via an accelerated graphics port (AGP) bus. The North bridge 606 couples CPU 602, memory 604, and graphics controller 608 to the other peripheral devices in the system through a primary expansion bus (BUS A) such as a PCI bus or an EISA bus. Various components that comply with the bus protocol of BUS A may reside on this bus, such as an audio device 614, a network interface card (NIC) 616, and a wireless communications module 618. These components may be integrated onto the motherboard, as shown, or they may be plugged into expansion slots 610 that are connected to BUS A. As technology evolves and higher-performance systems are increasingly sought, there is a greater tendency to integrate many of the devices into the motherboard which were previously separate plug-in components.

If other secondary expansion buses are provided in the computer, as is typically the case, another bridge logic device 612 is used to couple the primary expansion bus (BUS A) to the secondary expansion bus (BUS B). This bridge logic 612 is sometimes referred to as a “South bridge” reflecting its location vis-à-vis the North bridge 606 in a typical computer system drawing. Various components that comply with the bus protocol of BUS B may reside on this bus, such as hard disk controller 622, Flash ROM 624, and Super I/O controller 626. Slots 620 may also be provided for plug-in components that comply with the protocol of BUS B.

The Super I/O controller 626 typically interfaces to basic input/output devices such as a keyboard 630, a mouse 632, a floppy disk drive 628, a parallel port, a serial port, and sometimes various other input switches such as a power switch and a suspend switch. The Super I/O controller 626 often has the capability to handle power management functions such as reducing or terminating power to components such as the floppy drive 630, and blocking or reducing the frequency of the clock signals that drive the various components.

Clock signal control may be achieved by selecting between multiple clock signals being generated by a clock source, but in the preferred embodiment control is achieved through reconfiguring a clock chip 627 to alter the clock frequency when desired. Control of the clock chip 627 configuration may provided through a serial configuration bus (such as a JTAG bus), which is typically controlled by the Super I/O controller 626.

The Super I/O controller 626 may further assert System Management Interrupt (SMI) signals to various devices such as the CPU 602 and North bridge 606 to indicate special conditions pertaining to input/output activities such as sleep mode. The Super I/O controller 626 may incorporate a counter or a Real Time Clock (RTC) to track the activities of certain components such as the hard disk 622 and the primary expansion bus, inducing a sleep mode or reduced power mode after a predetermined time of inactivity. The Super I/O controller 626 may also induce a low-power suspend mode if the suspend switch is pressed, in which the power is completely shut off to all but a few selected devices.

When the computer initially boots up, each of the components is reset. The CPU 602 begins executing the BIOS firmware stored in Flash ROM 624. The BIOS typically includes a power-on self-test (POST) routine that tests and configures the various system components. As the CPU executes the POST routine, it may set the initial clock frequency of clock chip 627. The BIOS eventually passes control of the computer to the operating system, which is typically stored on hard disk 622. The processor 602 retrieves the operating system from the hard drive 622 and stores portions of it in memory 604. The operating system serves as an interface between the particular hardware of the computer and application software designed for generic system usage. Accordingly, the operating system includes device drivers (e.g., components 408, 410 in FIG. 4) that are designed by hardware manufacturers to provide standard interfaces to their hardware.

When not busy executing other tasks, the CPU executes the operating system instructions, and the CPU always returns to the operating system when it completes other tasks. Programs running on the computer are generally able to make “calls” to the operating system when they need to access the system hardware. In any event, once the operating system has been loaded, the computer is ready for use.

At some point, a user may wish to communicate wirelessly, and may activate software to initiate such communication. About the time that the wireless communication link is being established (i.e., just before, during, or shortly after), CPU 602 preferably executes spectrum control component 406 (FIG. 4) to adjust the computer's configuration in a manner that minimizes RF interference in the band(s) of wireless communication receive frequencies. Having adjusted the configuration, the computer continues with the wireless transaction. The computer configuration may be re-adjusted during the transaction in response to changes in conditions. For example, if the receive channel changes, the configuration may be re-adjusted to minimize RF interference in the new channels. Also, if computational loading requirements change, a new configuration may be chosen that maintains the low RF interference and satisfies the new loading requirements. Once the wireless transaction terminates, the computer may again be reconfigured, this time for optimal performance without regard to RF interference.

Numerous variations and modifications will become apparent to those skilled in the art once the above disclosure is fully appreciated. For example, the RF interference characteristics of the digital device may be measured and the measurements may be used to generate table(s) of preferred clock frequencies for given receive channels. The tables could then be included in the spectrum control component when that component is installed. Adaptive algorithms or self-learning techniques may be used, or deterministic rules may be preferred, for determining preferred digital device clock frequencies and/or device configurations. It is intended that the following claims be interpreted to embrace all such variations and modifications.

What is claimed is:

1. A digital apparatus that comprises:
a clock module configured to provide a clock signal;
a wireless module configured to receive radio-frequency (RF) signals, wherein the wireless module also receives RF interference from the digital apparatus; and
a control module configured to adjust the clock module to reduce RF interference in one or more selected frequency regions of interest.

2. The apparatus of claim 1, wherein the control module adjusts the clock module in response to information received from the wireless module.

3. The apparatus of claim 1, wherein the control module adjusts the clock module to shift harmonics of the clock signal outside the one or more selected frequency regions of interest.

4. The apparatus of claim 1, wherein the one or more selected frequency regions of interest include a receive channel for the RF signals.

5. The apparatus of claim 1, wherein the one or more selected frequency regions of interest vary from time to time.

6. The apparatus of claim 1, wherein the wireless module makes a measurement indicative of the RF interference in the one or more selected frequency regions of interest.

7. The apparatus of claim 6, wherein the control module adjusts the clock module to reduce the measurement.

8. A digital apparatus that comprises:
a clock module configured to provide a clock signal;
a wireless module that receives RF interference from the digital apparatus; and
a control module configured to adjust the clock module to determine which of multiple clock signal frequencies minimizes RF interference in one or more selected frequency regions of interest.

9. A device that comprises:
a clock source that provides a clock signal at a programmable frequency;
a wireless module that receives RF interference directly or indirectly caused by the clock signal; and
a control module that sets the programmable frequency of the clock signal so as to move at least some of the RF interference outside a frequency region of interest without stopping the clock signal altogether.

10. A method of reducing RF interference in digital equipment, the method comprising:
providing a clock signal at an initial clock rate;
identifying a frequency region in which to reduce RF interference; and
adjusting the clock signal to a different, nonzero clock rate that reduces RF interference in the identified frequency region.

11. The method of claim 10, wherein the frequency region is identified for receiving wireless communications to the digital equipment.

12. The method of claim 11, wherein the identified frequency region is not identified until a wireless communications transaction is initiated.

13. The method of claim 10, further comprising:
making measurements indicative of RF interference, wherein the adjusting includes trying a plurality of clock rates to determine which of the plurality of clock rates minimizes the RF interference.

14. A digital system that comprises:
a wireless communications device that receives RF interference from the digital system; and
a processor configured to execute a spectrum control procedure that configures the digital system so as to reduce said RF interference in one or more frequency regions during operation of the wireless communications device.

15. The system of claim 14, wherein the spectrum control procedure adjusts a clock signal frequency to shift at least some of the RF interference outside the one or more frequency regions.

16. The system of claim 14, wherein the spectrum control procedure alters a display scan rate to shift at least some of the of the RF interference outside the one or more frequency regions.

17. The system of claim 14, wherein the spectrum control procedure suspends operation of one or more peripherals during operation of the wireless communications device to reduce said RF interference.

18. The system of claim 14, wherein the spectrum control procedure shifts computational tasks to parallel hardware components more distantly spaced from the wireless communications device to reduce said RF interference.

19. The system of claim 14, wherein the processor receives information from the wireless communications device indicative of RF interference in the one or more frequency regions, and wherein the spectrum control procedure determines the effect of multiple configurations on said RF interference.

20. The system of claim 19, wherein the spectrum control procedure creates or maintains a table of preferred digital system configurations as a function of selected frequency regions.

21. A method of reducing RF interference in a digital system, the method comprising:
configuring the digital system to operate in an initial configuration;
identifying a frequency region in which to reduce RF interference; and
automatically reconfiguring the digital system in a manner that reduces RF interference in the identified frequency region.

22. The method of claim 21, wherein the reconfiguration includes altering a display scan rate to shift at least some of the RF interference outside the identified frequency region.

23. The method of claim 21, wherein the reconfiguration includes suspending operation of one or more system components.

24. The method of claim 21, wherein the reconfiguration includes shifting computational tasks from one hardware component to a second, substantially similar hardware component that is located further away from an RF interference sensitive component.

25. The method of claim 21, further comprising:
generating a table of system configurations to minimize RF interference in predetermined frequency regions.
